(19) United States
(12) Patent Application Publication
(10) Pub. No.: US 2010/0307151 A1
(43) Pub. Date: Dec. 9, 2010

(54) COMPRESSOR AND METHOD FOR SERVICING

(76) Inventor: Pierre B. French, Holmfirth (GB)

Correspondence Address: KRIEG DEVAULT LLP, ONE INDIANA SQUARE, SUITE 2800, INDIANAPOLIS, IN, 46204-2079, US

(21) Appl. No.: 12/795,407

(22) Filed: Jun. 7, 2010

Related U.S. Application Data
(63) Continuation of application No. PCT/GB2008/003834, filed on Nov. 14, 2008.

(30) Foreign Application Priority Data
Dec. 7, 2007 (GB) 0724022.9

(51) Int. Cl. F02B 37/00; B23P 6/00; F01D 25/16

(52) U.S. Cl. 60/605.1; 29/888.021; 417/407; 415/170.1

(57) ABSTRACT

A compressor has a diffuser section with one or more detachable wall portions that define a diffuser surface. The wall portions may be detachably connected to an intermediate portion of the compressor housing between the inlet and outlet and/or to the bearing housing of a turbocharger to which the compressor housing is connected. The diffuser wall portions can be easily detached once the compressor housing is removed so as to allow cleaning of deposits or simple replacement. This provides for easy servicing to avoid the compressor performance being compromised by a built up of deposits and particulates on the diffuser surfaces that is a particular problem in turbochargers that receive recirculated crank case ventilation gases from the engine.

### CROSS REFERENCE TO RELATED APPLICATIONS

The present application is a continuation of PCT/GB2008/003834 filed Nov. 14, 2008, which claims priority to United Kingdom Patent Application No. 0724022.9 filed Dec. 7, 2007, each of which is incorporated herein by reference.

The present invention relates to a compressor and more particularly, but not exclusively, to a compressor for use in a turbocharger. It also relates to a method for servicing such a compressor.

A compressor comprises an impeller wheel, carrying a plurality of blades (or vanes) mounted on a shaft for rotation within a compressor housing. Rotation of the impeller wheel causes gas (e.g. air) to be drawn into the impeller wheel and delivered to an outlet chamber or passage. In the case of a centrifugal compressor the outlet passage is in the form of a scroll volute defined by the compressor housing around the impeller wheel.

The turbocharger is a well-known device for supplying air to the intake of an internal combustion engine at pressures above atmospheric (boost pressures) and is widely used on automobiles and the like. The compressor of a turbocharger is driven by an exhaust gas turbine that is mounted on a common shaft. Exhaust gas from the internal combustion engine flows through the turbine and drives the turbine wheel in rotation, which, in turn, rotates the compressor impeller. Air is drawn through an axial inlet of the compressor housing and compressed air is delivered to the intake manifold of the internal combustion engine, thereby increasing engine power.

During operation of a turbocharged internal combustion engine high pressure combustion gases escape from between the pistons and the cylinders in which they reciprocate into the crankcase. These “blow-by” gases combine with engine oil in the crankcase. It is desirable to release the pressure in the crankcase as it will tend to build to such a magnitude that oil will begin to leak past seals such as those around the crankshaft. This is clearly undesirable. Historically such crankcase gases have been vented to atmosphere but this is no longer allowed by modern emission regulations and so a crankcase ventilation filter is usually fitted between the vent from the crankcase to remove oil vapour and the gases are recirculated to the air inlet system of the engine for combustion with the usual intake of air and fuel. For a turbocharged engine these crankcase ventilation (CCV) gases are typically fed into the turbocharger inlet and through the compressor inlet.

When such crankcase gases pass through the compressor stage of a turbocharger they are heated by the compression process and form carbon deposits in the compressor housing. Accumulation of such deposits reduces the efficiency of the compressor including reducing the boost pressure achievable by the compressor and thereby altering the performance and emission of the engine. It is therefore necessary to incorporate a cleaning routine in the regular servicing of a turbocharger compressor so as to remove the deposits. Such deposits are generally “burnt” on to outlet surfaces of the compressor and build up over time. As such they are difficult to remove, requiring the application of solvents and/or the use of mechanical cleaning processes and the process is therefore labour intensive and time-consuming. The cleaning process can be conducted by removing the turbocharger from the engine environment in which it operates but this leaves the potential for incorrect re-fitting and damage whilst it is removed. If the turbocharger remains in-situ, the compressor cover has to be removed to expose the compressor wheel and access is difficult meaning that effective cleaning is not always possible. Moreover, damage can occur to the compressor wheel during this process. In addition, debris or deposits cleaned from the compressor housing flange can fall behind the compressor wheel

It is one object of the present invention, amongst others, to provide for an improved, or alternative, compressor structure.

According to a first aspect of the present invention there is provided a method for servicing a compressor having a compressor housing defining an inlet, an outlet and an intermediate portion, comprising detaching at least one wall portion from the intermediate portion, the at least one wall portion defining at least part of a diffuser surface, and attaching at least one clean wall portion.

According to a second aspect of the present invention there is provided a method for servicing a compressor having a compressor housing defining an inlet and an outlet and an intermediate portion, the compressor housing being connected to a bearing housing in which a shaft of the compressor is supported in bearings, a diffuser portion being defined between, the intermediate portion of the compressor housing and the bearing housing, ‘ comprising separating the compressor and bearing housings and detaching at least one wall portion from at least one of the intermediate portion and the bearing housing, the at least one wall portion defining at least part of a diffuser surface of the compressor, and attaching at least one clean wall portion.

The detached at least one wall portion may be cleaned of deposits and reattached or may be discarded and replaced by another new or cleaned wall portion.

According to a third aspect of the present invention there is provided a compressor comprising a housing for an impeller wheel that is rotatable about an axis, the housing defining a gas inlet, a gas outlet and an intermediate portion between the inlet and outlet, the intermediate portion defining a first surface across which outer edges of the impeller wheel sweep during rotation, and a diffuser section provided by a first diffuser surface extending towards the outlet, the diffuser section having at least one first wall portion that defines a surface that forms at least part of the first diffuser surface, the at least one first wall portion being detachably connected to the intermediate portion of the housing, the surface defining at least one aerodynamic, axially projecting vane.

The detachable nature of the at least one first wall portion means that it can be removed easily for cleaning or disposal. There may be several wall portions that make up the diffuser surface, or simply make up a portion of the diffuser surface with the rest of it being defined by the intermediate portion of the housing or another part. Any form of detachable connector may be used between the wall portion and the intermediate portion.

The diffuser section may be substantially annular, or annular, and may extend radially outwards from the surface across which the outer edges of the impeller wheel sweep.

The at least one first wall portion may be detachably connected to an annular face of the intermediate portion and may itself be annular. The annular face may be formed by a recess in the intermediate portion.

The diffuser section may have at least one second wall portion and this may define at least part of a second diffuser surface opposite to and axially spaced from the first diffuser surface. The at least one second wall portion may be detachably connected to a supporting wall which may be provided by a bearing housing to which the compressor housing is connected. It may be connected into a recess defined in the supporting wall. Any form of releasable connection may be provided.

There may be at least one spacer between the first and second diffuser surfaces so as to ensure they define an appropriately size diffuser gap between the two. The spacer may be aerodynamically shaped and may be in the form of a vane. The at least one spacer may extend from one of the diffuser surfaces and its end may be received in a corresponding recess in the opposite diffuser surface.

The wall portions may be rigid.

According to a fourth aspect of the present invention there is provided a compressor comprising a housing for an impeller wheel that is rotatable about an axis, the housing defining a gas inlet, a gas outlet and an intermediate portion between the inlet and outlet, the intermediate portion defining a first surface across which outer edges of the impeller wheel sweep during rotation, and a diffuser section provided by a first diffuser surface extending towards the outlet, the diffuser section having at least one first wall portion that defines a surface that forms at least part of the first diffuser surface, the at least one first wall portion being detachably connected to the intermediate portion of the housing, the diffuser section being absent of flow directing vanes.

It will be appreciated that the diffuser section might be provided with supports (e.g. struts or connectors) that may extend from the first wall portion.

A further aspect of the present invention relates to a bearing housing for connection to a compressor housing of a turbocharger, the bearing housing having at least one detachable wall portion defining at least part of a diffuser surface for location opposite a diffuser surface of the compressor housing.

A yet further aspect of the present invention relates to a turbocharger comprising a compressor as defined above, a compressor impeller wheel in the compressor housing and a turbine connected to the compressor impeller wheel, hi the context of a turbocharger in some embodiments the compressor housing can be simply removed with the turbocharger in-situ so that the at least one first detachable wall portion can be removed easily.

A yet further aspect of the present invention relates to a turbocharger comprising a compressor, a turbine and a bearing housing as defined above and disposed intermediate the compressor and the turbine.

Specific embodiments of the present invention will now be described, by way of example only, with reference to the accompanying drawings, in which:

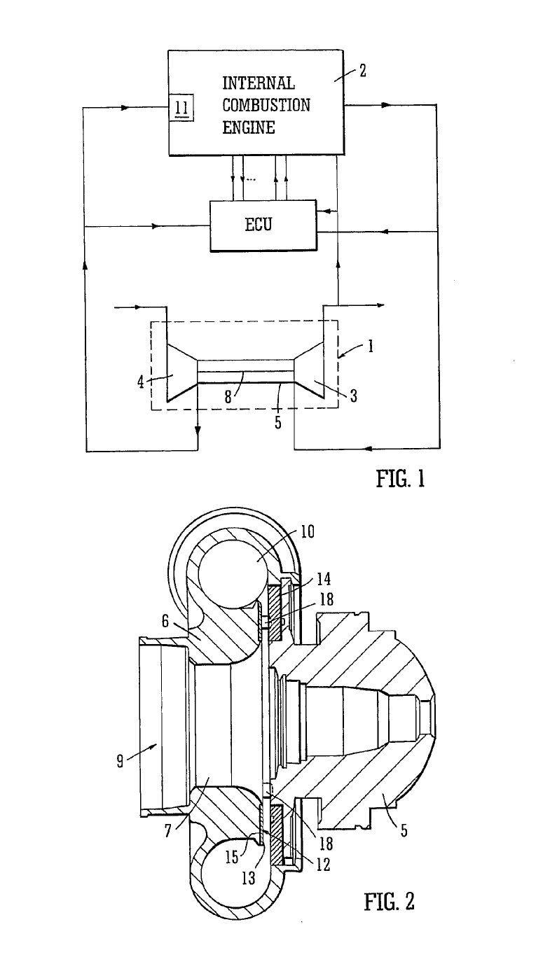

FIG. 1 is a schematic representation of a turbocharger fitted with a compressor in accordance with the present invention;

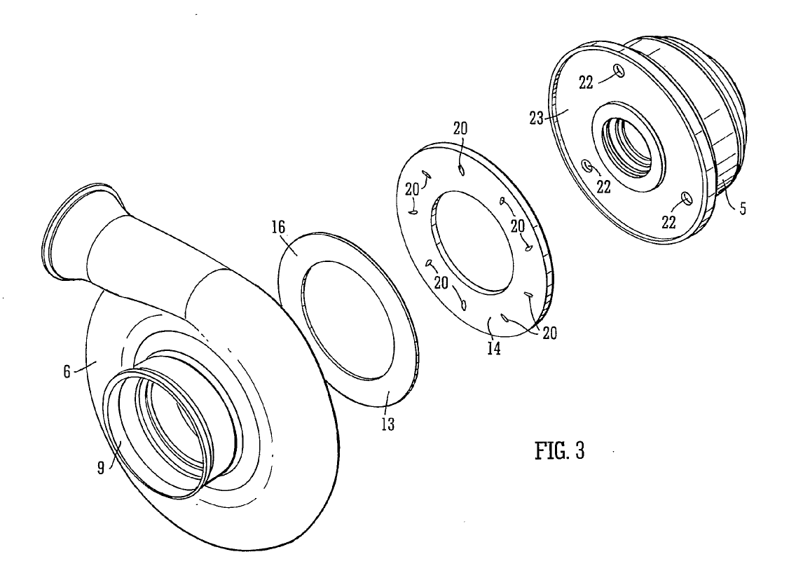

FIG. 2 is a partially sectioned side view of a compressor in accordance with the present invention and fitted to a bearing housing of the turbocharger, the impeller of the compressor being represented in dotted line;

FIG. 3 is an exploded view of the components of FIG. 2 shown from one end; and

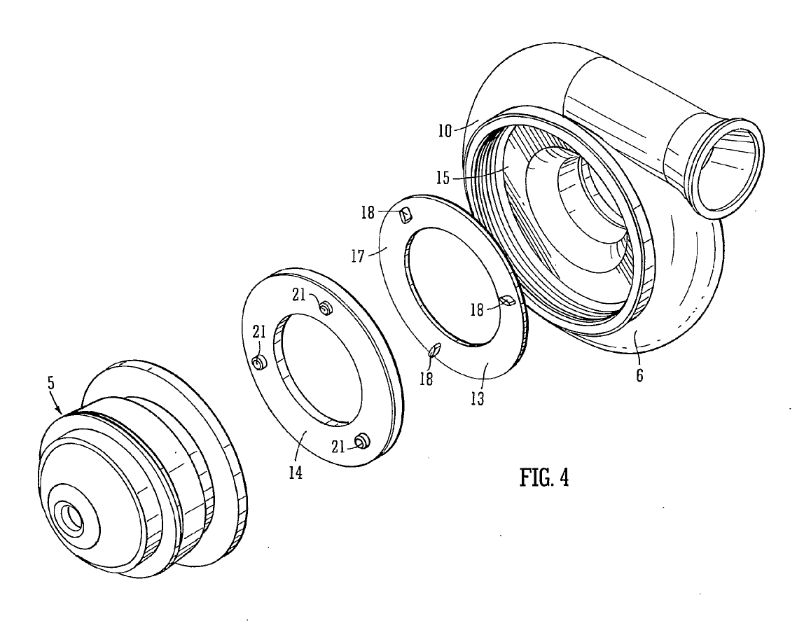

FIG. 4 is an exploded view of the components of FIG. 2 shown from the other end;

Referring to now to the drawings, FIG. 1 shows the turbocharger 1 connected to an internal combustion engine 2 of a vehicle. The operation of the engine 2 and the turbocharger 1 is controlled by an on-board ECU in the usual manner.

The turbocharger 1 comprises a turbine 3 connected to a compressor 4 via a central bearing housing 5. The compressor 4, which is shown in more detail in FIGS. 2 to 4, comprises a compressor housing 6 within which an impeller wheel is rotatably supported at one end of a turbocharger shaft 8. The compressor impeller wheel is not shown in the figures but the volume in which it is located is represented by reference numeral 7. As is conventional, it comprises a hub from which a plurality of blades extends outwardly. The turbine 3 similarly comprises a turbine wheel (not shown) that is rotatably supported on the other end of the shaft 8 within a turbine housing that is connected to the compressor housing 6 via the bearing housing 5. Since the invention relates to the structure of the compressor 4, there will be no detailed description of the turbine or bearing housing components.

The compressor housing 6 is shown in the figures as being a unitary construction but it will be understood that it may be comprised of multiple parts.

In operation, exhaust gas from an internal combustion engine 2 flows through the turbine 3 and drives the turbine wheel in rotation, which, in turn, rotates the compressor impeller wheel. The radially outer edges of the impeller wheel blades sweep over the adjacent surface of the housing and air is drawn through an inlet 9 (see FIG. 2) of the compressor housing 6 so as to be compressed by the impeller wheel before it is delivered to an outlet scroll volute 10 from where it is supplied to an intake manifold 11 (FIG. 1) of the internal combustion engine 2, thereby increasing engine power. The operation of the engine and the turbocharger is controlled by the ECU.

The high velocity, low pressure air that leaves the impeller blades for the outlet scroll volute 10 passes through a diffuser section 12 of the compressor housing 6 that serves to decelerate the air and convert it to high pressure before it exits the housing 6. The diffuser 12 is a substantially annular passage disposed at the radially outer tips of the impeller wheel space 7 and defined between facing surfaces of annular, rigid wall portions 13, 14 of the compressor housing and the bearing housing. The surface of the wall portion 13 effectively provides a continuation of the surface of the housing that is swept by the impeller wheel.

The wall portions 13, 14 of the diffuser 12 are detachable from the respective compressor and bearing housings 6, 5 as can be seen from FIGS. 3 and 4. A first wall portion 13 is detachably connected a rear face of the compressor housing 6 by one or more suitable fixings that allow for simple and quick release, hi the embodiment shown in the figures the wall portion 13 simply overlies an annular face 15 defined towards the rear of the compressor housing 6 radially inboard of the outlet volute 10. hi an alternative embodiment the first wall portion is received in a recess in the housing and a seal, such as a lip seal, disposed between the periphery of the wall portion and the edge of the recess provides friction fit retention. A first surface 16 of the first wall portion 13 which faces the annular face 15 of the compressor housing 6 is substantially planar whilst the opposite surface 17 (facing the bearing housing 5) has a plurality of axially projecting, angularly spaced vanes 18 that serve as spacers. The vanes 18 are aerodynamically shaped in the radial direction so that the flow of air to the outlet is not impaired significantly. Other spacer shapes could be used besides aerodynamic vanes provided that they ensure the required gap length is present between the wall portions so that correct compressor performance is achieved, hi fact, aerodynamic vanes for directing the flow of air may be completely omitted in some embodiments falling within the scope of the invention.

The second wall portion 14 of the diffuser 12 is detachably connected to the bearing housing 5 and has a plurality of recesses 20 defined on one surface for receiving the ends of the vanes 18 or spacers in a friction fit or a snap-fit connection or the like. There are more recesses 20 than vanes 18 so that the two wall portions 13, 14 can be angularly positioned relative to one another in several possible orientations. There may be provided two or more sets of recesses 20 for the spacer vanes 18, the sets being angularly offset and of different depths such that the wall portions 13, 14 can be connected in different orientations, each orientation offering a different spacing and therefore a different diffuser width. The surface of the second wall portion 14 that is opposite to the recesses 20 has a plurality of raised elements 21 in the shape of buttons for receipt in complementary recesses 22 defined in an end wall 23 of the bearing housing 5. The raised elements 21 are a friction fit in the complementary recesses 22 and it will be understood that any suitable complementary shapes may be employed.

The diffuser section 12 allows the wall portions 13. 14 to be easily detached for cleaning purposes when the compressor housing 6 disconnected and removed from the bearing housing 5. The removed wall portions 13, 14 can be cleaned in a suitable location by immersion in cleaning fluids and scrubbing, if necessary, before being reattached. Alternatively, the wall portions 13, 14 may be made from a suitably low cost material and manufacturing process (such as for example, die cast plastics that can withstand the relatively high temperatures in the diffuser area) that they can simply be discarded and replaced without significant financial penalty. Embodiments are contemplated in which only one diffuser wall portion 13, 14 is detachable with the other being defined by the housing 5, 6. In such embodiments the wall portion defined by the housing may have multiple sets of recesses 20, each set having recesses 20 of a depth different to that of other sets to allow difThrent diffuser widths to be provided.

The diffuser wall portions may be detached and cleaned as part of a specific servicing requirement or as part of any routine service of the compressor or turbocharger. In the embodiment where both wall portions are detachable a servicing unit can stock one detachable cartridge comprising an assembly of the two walls which is designed to fit multiple compressor housings of different sizes, the wall portions being configurable as described above to vary the diffuser width. Instructions for fitting, detachment and/or cleaning may be provided on one of the wall portions and/or on the housings.

Any kind of suitable connection may be employed to allow the wall portions to be detachable. For example the wall portions 13, 14 may be a friction-fit or snap-fit with the housings 5, 6 in which they are supported. Alternatively fixings such as screws or bolts may be used. In some applications an adhesive may be used between contact surfaces that are of limited area so as to allow them to be prised apart and detached easily. The two wall portions 13, 14 may be detachably connected together in any convenient manner or, alternatively. may be permanently secured together such that they form an assembly of two spaced apart walls that is detachably connected to the compressor housing 6 and/or the bearing housing 5.

The wall portions may be manufactured from any suitable material including plastics, particularly thermoset plastics, or metals such as aluminium or steel. They may be manufactured in any suitable manner such as, for example, injection moulding, pressing or stamping.

It will be appreciated that numerous modifications to the above described designs may be made without departing from the scope of the invention as defined in the appended claims. For example, the wall portions may form only part of the diffuser surfaces, the rest being provided by the walls of the respective housings. Moreover, it will be understood that one or both wall portions may be detachable using any suitable detachable connection. Furthermore, the walls may be flexible.

1-24. (canceled)

25. A method for servicing a compressor having a compressor housing defining an inlet, an outlet and an intermediate portion, comprising detaching at least one wall portion from the intermediate portion, the at least one wall portion defining at least part of a diffuser surface, and attaching at least one clean wall portion.

26. A method according to claim 1, wherein the detached at least one wall portion is cleaned and re-attached.

27. A method according to claim 1, wherein the detached at least one wall portion is replaced by the at least one clean wall portion.

28. A method for servicing a compressor having a compressor housing defining an inlet and an outlet and an intermediate portion, the compressor housing being connected to a bearing housing in which a shaft of the compressor is supported in bearings, a diffuser portion being defined between the intermediate portion of the compressor housing and the bearing housing, comprising separating the compressor and bearing housings and detaching at least one wall portion from at least one of the intermediate portion and the bearing housing, the at least one wall portion defining at least part of a diffuser surface of the compressor, and attaching at least one clean wall portion.

29. A method according to claim 4, wherein the detached at least one wall portion is cleaned and re-attached.

30. A method according to claim 4, wherein the detached at least one wall portion is replaced by the at least one clean wall portion.

31. A compressor comprising a housing for an impeller wheel that is rotatable about an axis, the housing defining a gas inlet, a gas outlet and an intermediate portion between the inlet and outlet, the intermediate portion defining a first surface across which outer edges of the impeller wheel sweep during rotation, and a diffuser section provided by a first diffuser surface extending towards the outlet, the diffuser section having at least one first wall portion that defines a surface that forms at least part of the first diffuser surface, the at least one first wall portion being detachably connected to the intermediate portion of the housing, the surface defining at least one aerodynamic, axially projecting vane.

32. A compressor according to claim 7, wherein the diffuser section extends substantially radially outwards from the surface across which the outer edges of the impeller wheel sweep.

33. A compressor according to claim 7, wherein the at least one first wall portion is at least partially annular.

34. A compressor according to claim 7, wherein the at least one wall portion is detachably connected to an annular face of the intermediate portion.

35. A compressor according to claim 7, further comprising at least one second wall portion and defining at least part of a second diffuser surface opposite to and axially spaced from the first diffuser surface, the at least one second wall portion being detachably connected to a supporting wall.

36. A compressor according to claim 11, in combination with a turbocharger bearing housing wherein said supporting wall is defined by the bearing housing.

37. A compressor according to claim 7, wherein the at least one aerodynamic vane serves as a spacer between the first and second diffuser surfaces.

38. A compressor according to claim 7, wherein the at least one aerodynamic vane is integrally formed with the surface of the at least one first wall portion.

39. A compressor according to claim 7, wherein the at least one aerodynamic vane is retained in a fixed relationship with respect to the at least one first wall portion.

40. A compressor according to claim 7, wherein the surface of the at least one first wall portion, once detached, is exposed so that it may be cleaned.

41. A compressor according to claim 7, wherein there is a detachable connection between an inner or outer periphery of the at least one detachable wall portion and a recess defined in the compressor housing.

42. A bearing housing for connection to a compressor housing of a turbocharger, the bearing housing having at least one detachable wall portion defining at least part of a diffuser surface for location opposite a diffuser surface of the compressor housing.

43. A bearing housing according to claim 18, wherein the at least one detachable wall portion defines at least one aerodynamic vane.

44. A bearing housing according to claim 18, wherein at least one aerodynamic vane is fixed to the detachable wall portion.

45. A bearing housing according to claim 18, wherein the at least one detachable wall portion is at least partially annular.

46. A bearing housing according to claim 18, wherein there is a detachable connection between an inner or outer periphery of the at least one detachable wall portion and a recess defined in the bearing housing.

47. A bearing housing according to claim 18, wherein the at least one detachable wall portion defines a surface which, once the wall portion is detached, is exposed so that it may be cleaned.

48. A bearing housing according to claim 19, wherein the diffuser surface is substantially planar other than said at least one aerodynamic vane.

49. A turbocharger comprising a compressor according to claim 7, a compressor impeller wheel in the compressor housing and a turbine connected to the compressor impeller wheel.

50. A turbocharger comprising a compressor, a turbine and a bearing housing according to claim 18 disposed intermediate the compressor and the turbine.
